(19) United States
(12) Patent Application Publication
(10) Pub. No.: US 2010/0136411 A1
(43) Pub. Date: Jun. 3, 2010

(54) Prismatic Cell With Outer Electrode Layers Coated On A Single Side

(75) Inventors: Sang-Young YOON, Lexington, MA (US); Whan Jin Roh, Seoul (KR); Myoung-Shin Hong, Seongnam-City (KR); Seong-Woo Park, Yongin-City (KR)

Correspondence Address: WILMERHALE/BOSTON, 60 STATE STREET, BOSTON, MA, 02109, US

(73) Assignee: A123 Systems, Inc., Watertown, MA (US)

(21) Appl. No.: 12/502,855

(22) Filed: Jul. 14, 2009

Related U.S. Application Data
(60) Provisional application No. 61/080,544, filed on Jul. 14, 2008.

(51) Int. Cl. H01M 2/18; H01M 4/82

(52) U.S. Cl. 429/144; 29/623.5

(57) ABSTRACT

Embodiments of the present invention provide an electrochemical cell including a stack of electrode layers and separator layers. The electrode layers include anode layers and cathode layers disposed in an alternating manner and separated by the separator layers. The two outer electrode layers of the stack are of the same type and are coated with an active material on an inward-facing surface only. The electrochemical cell may include two or more insulating layers disposed at the two ends of the electrode stack, and a pouch enclosing the electrode stack and the insulating layers.

### CROSS-REFERENCE

This application is a non-provisional application of U.S. Provisional Application No. 61/080,544, filed Jul. 14, 2008.

### FIELD OF THE INVENTION

Exemplary embodiments consistent with the present invention generally relate to a battery module design, and more particularly, to a prismatic cell design.

### BACKGROUND

Electrochemical cell shapes are generally classified as either prismatic or cylindrical. Cylindrical cells have cylindrical housings. Common examples of cylindrical batteries are standard alkaline sizes AA, AAA, C and D. Prismatic cells have prismatic housing shapes, such as parallelepipeds. Common examples of prismatic cells include standard 12 V car batteries. An electrochemical cell can be, for example, a lithium ion cell.

A prismatic cell can be constructed by stacking positive and negative electrode sheets together. Positive electrode sheets (i.e., anode sheets) and negative electrode sheets (i.e., cathode sheets) are separated by electrically insulating separator sheets. The stacked sheets can be further rolled up, which may be referred to as stack winding, or folded back and forth, which may be referred to as zigzag folding. A combination of these two approaches may also be used. The rolled or folded sheets can be sealed in a pouch, which can be made, for example, by aluminum/polymer laminate. A prismatic cell can also be made by winding the electrodes around a flat mandrel, creating a “wound, flat wrap” design. Additionally, polymer or polymer/ceramic powder coated separator sheets can be used to improve stack pressure between cathodes and anodes, which improves cycle performance of the prismatic cell.

Conventional prismatic cells have every anode sheet and cathode sheet coated with an active material on both sides. When the electrode sheets come into contact with electrolyte, the coated electrodes enable an electrochemical reaction within the cell so that electricity is stored or produced in the cell. While coating both sides of every electrode with active material simplifies the manufacturing process, conventional cells suffer from inefficiencies with respect to materials, storage and size.

### SUMMARY OF THE NON-LIMITING EMBODIMENTS OF THE INVENTION

Embodiments of the present invention provide an electrochemical cell including a stack of electrode layers and separator layers. The electrochemical cell may be a lithium ion cell. According to an aspect of the invention, the electrode layers include anode layers and cathode layers disposed in an alternating manner and separated by the separator layers. The two outermost electrode layers of the stack are of the same type and are coated on the inward-facing surface only with an active material. In one of more embodiments, the outward facing surfaces of the two outer electrodes have a coating of polymer, polyimide taping (PI), polyvinylidene fluoride (PVDF), or the like. The electrochemical cell may further include two or more insulating layers disposed at the two ends of the electrode stack, and a pouch enclosing the electrode stack and the insulating layers.

In one of more embodiments, the insulating layers comprise outer separator layers and two metallic layers are on outer sides of the outer separator layers.

In one of more embodiments, the insulating layers comprise polymer coating layers disposed on outward-facing surfaces of the outer electrode layers.

In one of more embodiments, the two outer electrode layers are anodes.

In one of more embodiments, the two outer electrode layers are cathodes.

In one of more embodiments, the active material is comprised of at least one of binder and conducting carbon.

In one of more embodiments, the separator layers are coated with at least one of polymer or polymer ceramic powder.

In one of more embodiments, the outer surfaces of the electrodes at opposing ends of the electrode stack are coated with polyvinylidene fluoride.

In one of more embodiments, polyimide taping is added to the outward facing surfaces of the electrodes at opposing ends of the electrode stack.

According to another exemplary aspect of the invention, a method is provided for constructing an electrochemical cell. A stack of electrode layers comprising cathode and anode layers are provided, the outermost electrode layers being the same type. The cathode and anode layers are separated by separating layers. The electrode layers are coated with an active material, wherein each electrode layer is coated with the active material except for the outward facing surface of the electrodes at opposing ends of the electrode stack. In one of more embodiments, the active material is comprised of at least one of binder and conducting carbon.

In one of more embodiments, two or more insulating layers are disposed at opposing ends of the electrode stack.

In one of more embodiments, the electrode layers and separating layers are disposed inside a pouch.

In one of more embodiments, the separating layers are coated with at least one of polymer, polymer/ceramic powder, polypropylene, polyethylene, nylon, cellulosic layers and polymer composites.

In one of more embodiments, at least two metallic layers are disposed respectively at opposing ends of the electrode stack.

In one of more embodiments, insulating layers are disposed respectively between the outer surface of the outer most electrodes and the at least two metallic layers.

In one of more embodiments, the outer surfaces of the electrodes at opposing ends of the electrode stack are coated with polyvinylidene fluoride.

In one of more embodiments, the outward facing surfaces of the electrodes at opposing ends of the electrode stack are coated with a polymer.

Embodiments of the invention provide features over conventional cells. For example, electrochemical cells according to exemplary embodiments of the invention may achieve higher space efficiency and capacity as compared with conventional cells. Coating of electrodes requires considerable space, such that when designing a cell, a manufacturer needs to consider the cumulative space taken by each coated electrode included in the cell. In an electrochemical cell according to exemplary embodiments of the invention, the cumulative space required decreases significantly because the outermost layers of the individual prismatic cells are not coated with active material, resulting in higher space efficiency.

Exemplary embodiments of the invention also provide protection against corrosion or short conditions within the cells by using the disclosed insulating layers. Further, storage performance of the cell is increased due to the absence of the active layer on the outer electrodes preventing unnecessary transfer of lithium, which would otherwise be present in conventional cells.

### BRIEF DESCRIPTION OF THE DRAWINGS

Exemplary embodiments of the invention are described with reference to the following figures, which are provided for the purpose of illustration only.

FIG. 1 is a diagram illustrating internal components of an electrochemical cell according to a first exemplary embodiment of the invention;

FIG. 2 is a diagram illustrating internal components of an electrochemical cell according to a second exemplary embodiment;

FIG. 3 is a diagram illustrating internal components of an electrochemical cell according to a third exemplary embodiment;

FIG. 4 is a diagram illustrating internal components of an electrochemical cell according to a fourth exemplary embodiment;

FIG. 5 is a diagram illustrating internal components of an electrochemical cell according to a fifth exemplary embodiment; and

FIG. 6 is a top view of an electrochemical cell with a pouch.

### DETAILED DESCRIPTION OF NON-LIMITING EMBODIMENTS OF THE INVENTION

Exemplary embodiments of the present invention provide an electrochemical cell and method of making the same, having an outer electrode layer or sheet in addition to an equal number of anode electrode layers and cathode electrode layers. The outermost or electrode layers of the prismatic cell are coated with an active material on a single side only. The prismatic cell achieves a higher space efficiency and capacity as compared with conventional prismatic cells.

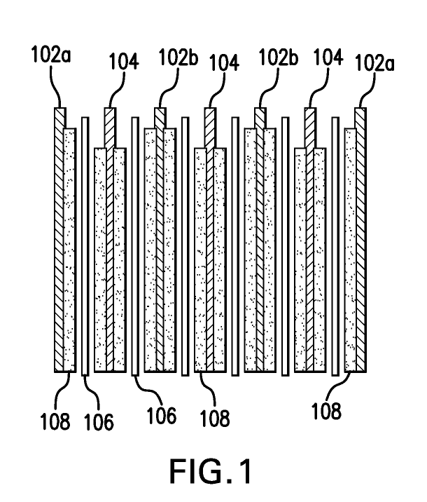

FIG. 1 is a diagram illustrating internal components of a prismatic cell according to an exemplary embodiment of the invention. As shown, the internal components include outer anode sheets 102a, inner anode sheets 102b, and cathode sheets 104 stacked together in an alternating manner. Anode sheets 102a, 102b can be, for example, copper foils, and cathode sheets 104 can be, for example, aluminum foils. The anode sheets 102a, 102b and the cathode sheets 104 are separated by electrically insulating separator sheets 106. Separator sheets 106 can be made of polypropylene, polyethylene, nylon, cellulosic layers, polymer composites, polymer or polymer/ceramic powder, or any other suitable materials.

As shown in FIG. 1, the outer most electrode layers are both anode sheets 102a, such that the prismatic cell has more anode sheets than cathode sheets. Each of the two outer electrode layers 102a has a coating of an active material 108 on only a single side, which is on the inward-facing surface. The coating 108 may, for example, be comprised of the active material with binder and conducting carbon. As shown in the embodiment of FIG. 1, the outer surface is not positioned against an opposing electrode, and therefore does not contribute to the storage or production of electricity. In a lithium ion cell, coating of the outward facing surface of the outer electrodes of the stack with a layer of active material can trap lithium into the layer of active material, resulting in the loss of usable lithium, which causes a loss of battery capacity. The outward-facing surfaces of the outer electrode layers 102a are not coated with the active material, according to exemplary embodiments of the present invention. The inner electrode layers (i.e., electrode layers disposed between the two outer electrode layers 102a), whether anode sheets 102b or cathode sheets 104, may have coating 108 on both sides. The coating 108 enables electrochemical reactions in the cell in the presence of electrolyte. The active material on cathode sheets 104 does not extend as far as the active material on anode sheets 102. The active material covering a larger portion of the anode sheet than cathode sheet helps reduce lithium plating as the electrochemical cell is in use. FIGS. 1-5 illustrate top portions of the electrochemical cell stack. One of ordinary skill in the art will appreciate that the bottom portions of the cathode and anode layers are the same as the top portions in the sense that the active material on cathode sheets 104 does not extend as far as the active material on anode sheets 102.

Because there is no active material coating 108 on the outward-facing surface of the outer electrode layers 102a, the volume of the electrode stack within the prismatic cell is reduced. The space that is saved may allow an additional pair of electrodes to be placed within the prismatic cell. Capacity of the cell is also increased because elimination of coating at the outer electrode reduces trapping of lithium, which would otherwise be present if the outer coating were applied. Battery cell designs according to embodiments of the present invention also have better storage performance, including storage at higher temperatures. Higher temperatures cause the energy in a lithium ion battery to dissipate at a faster rate than lower temperature conditions. An exemplary feature of the invention is that having no active material on the outward-facing surface of the outermost electrodes does not trap lithium in the outermost electrode and increases storage capacity, which is increasingly important as temperatures rise. Accordingly, the electrochemical cell can be stored at higher temperatures with less dissipation of energy.

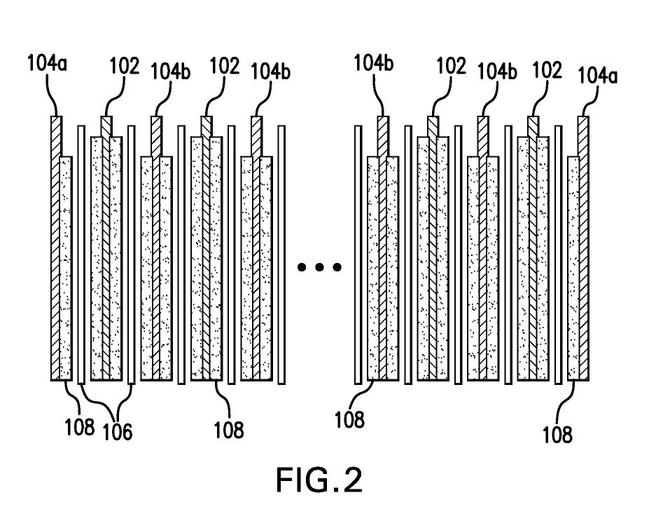

FIG. 1 shows a design in which there is an additional anode layer. Alternatively, a prismatic cell can have an additional cathode layer instead of an additional anode layer. As shown in FIG. 2, the two outer electrode layers are both cathode sheets 104a. Each of the two outer cathode sheets 104a has the active material coating 108 on a single side, which is the inward-facing surface of the outer cathode sheets. Similar to the embodiment shown in FIG. 1, the anode sheets 102 and the cathode sheets 104a, 104b are separated by separator sheets 106.

An additional benefit of the embodiments in FIGS. 1 and 2 is that there are fewer or no wrinkles present on an outside surface of a pouch containing the cell. This is because the outer electrode layers of the cell stack underneath the pouch material are bare foils without the coating 108. The pouch can have multiple layers, including an aluminum foil, a nylon or polyethylene terephthalate (PET) layer on the outside, and a polymer layer (e.g., polypropylene layer) on the inside. The layers can be laminated with adhesives or by heat. In some non-limiting embodiments, a battery pack can have multiple cells, and cooling pins (e.g., aluminum plates) attached to the surface of each cell to transfer heat away from the cell. An absence of wrinkles on the cell surface therefore increases the contact area between the cooling pins and the pouch or cell casing, which enhances heat transfer away from the cell. Additionally, the cells may be pressed against each other when placed into a pack. Uneven pressure, such as that caused by wrinkles in the electrode stack, can cause differential lithium plating and can decrease capacity or reduce cycle life.

The cells illustrated in FIGS. 1 and 2 can be constructed by stacking together electrode sheets along with separator sheets. Anode layers and cathode layers are disposed in an alternating manner. The two outer electrode layers can be either cathode layers or anode layers, and are each coated on a single side. Because the two outer electrode layers are of the same type, the number of cathode layers and the number of anode layers differ by one. The cell stack can be placed within a pouch, and the top and sides of the pouch can be sealed. The cell can then be activated. To activate a cell, in accordance with an exemplary embodiment of the invention, an electrolyte is introduced into the partially sealed cell in vacuum for a defined period of time to allow the electrolyte to wet the electrodes. The sides of the cell can then be heat sealed to a specified dimension, and any remaining seal material can be cut off and discarded. The cell is also subjected to a series of charge, discharge, and storage steps for various times and at various temperatures to optimize cell capacity.

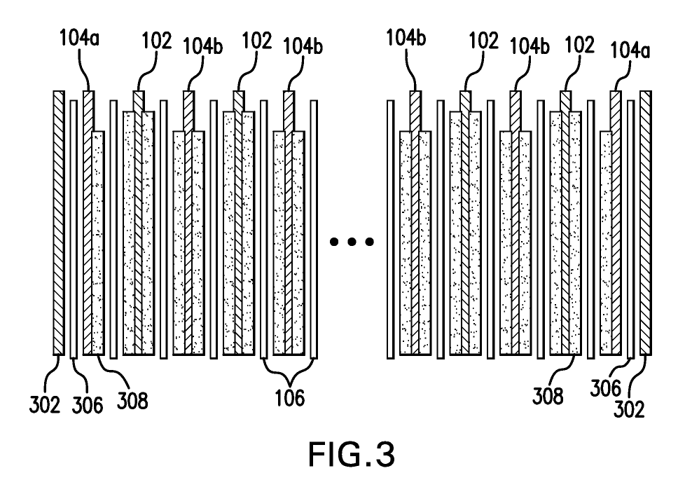

The outer electrodes within an electrochemical cell often suffer from corrosion. Also, short conditions may occur within a cell, causing safety concerns. One or more additional insulating layers can protect the outer electrodes against corrosion and can provide safety in the event of a short inside the cell. FIG. 3 is a diagram illustrating the internal components of a cell according to an exemplary embodiment having additional metallic layers 302, such as, for example, copper layers, disposed on the outside of the stack of electrode sheets. As shown, the cell stack in FIG. 3 includes anode sheets 102, outer cathode sheets 104a, inner cathode sheets 104b, and separator sheets 106 as previously shown. The two outer electrode layers 104a have an active material coating 308 on a single side, and the rest of the electrode layers are coated on both sides. The metallic foils 302 can be separated from the stack of electrodes by additional separator sheets 306 or other suitable insulating material, as shown. The additional metallic foils 302 improve safety and vibration protection of the cell by preventing contact, and therefore a short circuit, between the cell casing or pouch and the bare or uncoated electrode foils or cathode sheets 104a during vibration or ultrasonic welding.

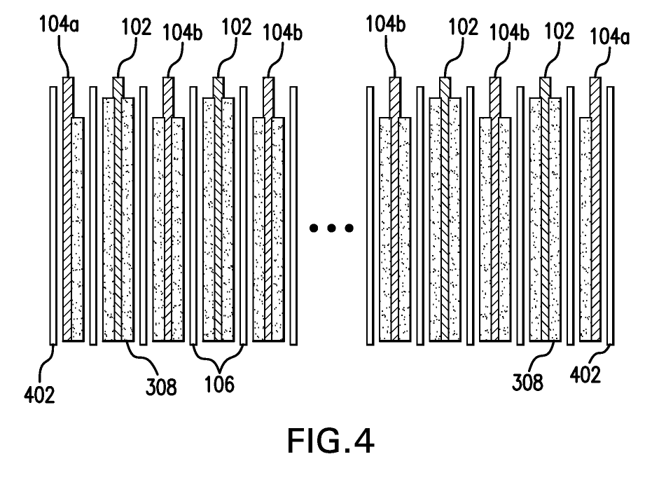

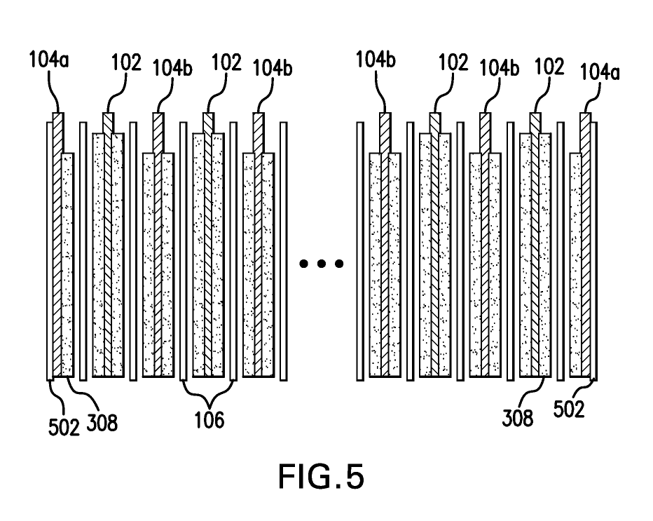

In the embodiment shown in FIG. 3, two metallic foils 302 and additional separator sheets are used to protect the internal cell components. Alternatively, polymer coating layers or PI taping can be added on the bare or uncoated electrode foils or cathode sheets 104a to serve similar purposes. FIG. 4 illustrates a non-limiting embodiment in which the polymer coating layers or PI taping 402 are placed on the outward-facing surface of the outer electrode layers 104a. FIG. 5 illustrates an exemplary embodiment in which a polyvinylidene fluoride (PVDF) coating 502 is used on the outward-facing surface of the outer electrode layers 104a. In some embodiments, extra coatings of the polymer layers or PI taping 402, or the PVDF coating 502 can be placed on the corner of the bare foil side of the outer electrode layers to further protect the inner components of the cell when inserted into a pouch. The layers 402 and 502 can also protect the electrodes against corrosion, and can provide safety in the event of a short inside the cell. The use of taping on the outer layers is of particular use for those configurations having a cathode as the outer electrode layer.

As previously indicated, coating of the outer electrode in a lithium ion cell may trap lithium in the outermost electrode layer. This results in the loss of battery capacity as usable lithium is decreased. In a non-limiting embodiment of the present invention, the use of a non-active coating on the outer most electrode, e.g., PI taping or PVDF coating, does not trap lithium in the outermost electrode layer.

Table 1 below demonstrates benefits of use cell according to embodiments of the present invention. Table 1 demonstrates the retention and recovery rates, i.e., discharge capacity retention after storage and discharge capacity recovery after one more cycle of charge and discharge, of an electrochemical cell at an elevated temperature of 70° C. More specifically, the table illustrates results from standard electrochemical cells versus two electrochemical cells with an outermost electrode having an active coating on only the inward facing surface of the electrode or half-coated outer layer (HCOL), according to embodiments of the present invention. The electrochemical cell demonstrated in Table 1 has a cathode as the outermost electrodes. The benefits attributed to the lack of active material on the outer cathode layers is similarly applicable to the embodiments having the outer electrode layers as anodes. The control or standard cell has an active coating on both sides of the outermost electrodes. The retention and recovery rates are demonstrated to be greater in the electrochemical cell according to embodiments of the present invention and lesser with prior art cells. For example, a fully charged cell, which is stored for 7 days at 70° C., has a retention rate of 83.94%, i.e., only 83.94% of the original charge is left. However, a cell according to embodiments of the present invention has a retention rate of 88.04% under the same conditions. Similarly, a prior art cell, which is stored for 7 days at 70° C. has a recovery rate of 84.47%. After the retention rate has been determined, the recovery rate is calculated by fully discharging and charging, i.e., cycling the cell, and determining the new maximum charge capacity with respect to the original full charge capacity being 100% state of charge. The new maximum charge capacity may be degraded due to normal cycling of cell or temperature conditions. The recovery rate for a cell according to embodiments of the present invention under the same conditions is 89.37%. The greater retention and recovery rates of the electrochemical cell according to embodiments are attributable to outermost electrode layer having an active coating on only one side, such that lithium is not trapped in the outermost electrode layer and dissipated from the cell.

TABLE 1

| | Storage at 70° C. | | | | | |
|---|---|---|---|---|---|---|
| | 3 days | | 7 days | | 14 days | |
| Design | Retention | Recovery | Retention | Recovery | Retention | Recovery |
| Control | 92.71% | 92.61% | 83.94% | 84.47% | 66.95% | 73.62% |
| | 93.23% | 94.60% | 86.74% | 88.59% | 68.43% | 69.78% |
| HCOL | 93.71% | 95.26% | 88.04% | 89.37% | 79.30% | 80.09% |
| | 93.82% | 95.37% | 88.71% | 89.74% | 79.66% | 79.91% |

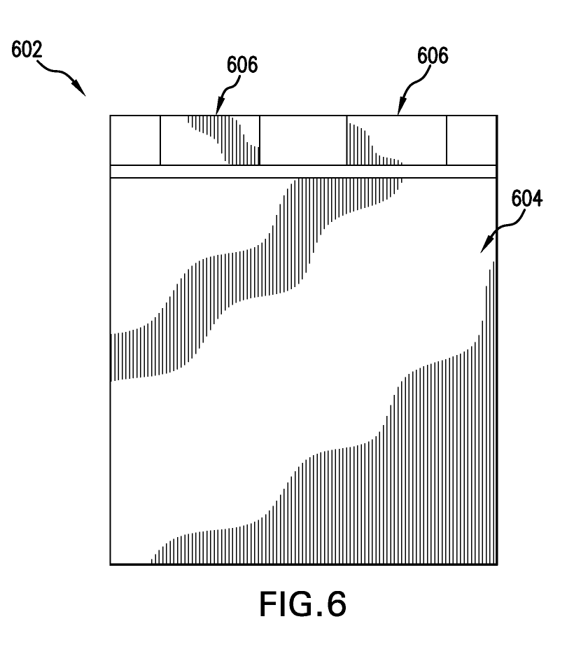

FIG. 6 is a top view of an electrochemical cell 602 according to an exemplary embodiment. The electrodes of the cell 602 are placed inside a pouch 604. Current collecting tabs 606 are attached to the electrodes. Because the outer electrode layers of the cell stack underneath the pouch 604 are electrodes without the active material coating on the outer surfaces, as described in exemplary embodiments above, wrinkles that would otherwise be present on the outer surface of the pouch 604 are reduced or not present, as opposed to traditional arrangements that would present wrinkles on the outer surface of the pouch 604.

Although the exemplary embodiments described above provide cell designs that have a stack of electrode layers, the principle of the invention can also be applied to benefit a wound flat wrap prismatic cell or a cylindrical cell. In these cases, an outer wrap of the cell is not coated on the outer surface, and the wrap can be surrounded by additional insulating layer(s).

The foregoing illustrates exemplary embodiments of the invention. Other modifications and variations of the invention will be readily apparent to those of skill in the art in view of the teaching presented herein. The foregoing is intended as an illustration, but not a limitation, upon the practice of the invention. It is the following claims, including all equivalents, which define the scope of the invention.

1. An electrochemical cell, comprising:
a stack of electrode layers and separator layers, the electrode layers comprising anode layers and cathode layers that are disposed in an alternating manner and are separated by the separator layers, the anode layers and the cathode layers having an active material coating on both sides, and
two outer electrode layers disposed at opposing ends of the stack, wherein the two outer electrode layers of the stack are of the same type and are coated with the active material on an inward facing surface only.

2. The electrochemical cell of claim 1, wherein an insulating layer is disposed over an outward facing surface of the outer electrodes.

3. The electrochemical cell of claim 1, wherein the electrode layers and the separator layers are provided inside a pouch.

4. The electrochemical cell of claim 1, wherein the cell is a lithium ion cell.

5. The electrochemical cell of claim 2, wherein the insulating layers comprise outer separator layers and two metallic layers are on outer sides of the outer separator layers.

6. The electrochemical cell of claim 2, wherein the insulating layers comprise polymer coating layers disposed on outward-facing surfaces of the outer electrode layers.

7. The electrochemical cell of claim 1, wherein the two outer electrode layers are anodes.

8. The electrochemical cell of claim 1, wherein the two outer electrode layers are cathodes.

9. The electrochemical cell according to claim 1, wherein the active material is comprised of an electroactive material and at least one of binder and conducting carbon.

10. The electrochemical cell according to claim 1, wherein the separator layers are comprised of at least one of polymer or polymer ceramic powder.

11. The electrochemical cell according to claim 2, wherein outward facing surfaces of the outer electrode layers are coated with polyvinylidene fluoride.

12. The electrochemical cell according to claim 2, wherein polyimide taping is added to outward facing surfaces of the outer electrode layers.

13. A method for constructing an electrochemical cell comprising:
arranging a stack of electrode layers comprising cathode and anode layers, the outermost electrode layers being the same type;
separating the cathode and anode layers by separating layers; and
coating the electrode layers with an active material, wherein each electrode layer is coated with the active material on both sides of the electrode except for the outward facing surface of the electrodes at opposing ends of the electrode stack.

14. The method according to claim 13, comprising disposing an insulating layer over the outward facing surface of the outer electrodes.

15. The method according to claim 13, comprising providing the electrode layers and separating layers inside a pouch.

16. The method according to claim 13, wherein the separating layers comprise at least one of polymer, polymer/ceramic powder, polypropylene, polyethylene, nylon, cellulosic layers and polymer composites.

17. The method according to claim 13, comprising disposing at least two metallic layers at opposing ends of the electrode stack.

18. The method according to claim 17, comprising disposing two insulating layers between the outer surface of the outer most electrodes and the at least two metallic layers.

19. The method according to claim 13, comprising coating the outer surface of the electrodes at opposing ends of the electrode stack with polyvinylidene fluoride.

20. The method according to claim 13, comprising adding polyimide taping to the outward facing surface of the electrodes at opposing ends of the electrode stack.

21. The method according to claim 13, comprising coating the outward facing surface of the electrodes at opposing ends of the electrode stack with a polymer.

22. The method according to claim 13, wherein the active material is comprised of an electroactive material and at least one of binder and conducting carbon.
